(19) United States
(12) Patent Application Publication
(10) Pub. No.: US 2009/0292553 A1
(43) Pub. Date: Nov. 26, 2009

(54) Tax insurance method, and system

(75) Inventor: Vladimir Trakhtman, New York, NY (US)

Correspondence Address: VLADIMIR TRAKHTMAN, 175 ELDRIDGE ST. #4F, NEW YORK, NY, 10002, US

(73) Assignee: Vladimir Trakhtman

(21) Appl. No.: 12/154,553

(22) Filed: May 22, 2008

(51) Int. Cl. G06Q 40/00; G06Q 50/00

(52) U.S. Cl. 705/2; 705/4

(57) ABSTRACT

Tax insurance method, and system is offered to form an insurance plan combining together at least two separate but related contracts. It helps insurance providers to support different but related clients applying a legally secured united technology and to collect financial contributions of clients-investors, to satisfy financial and other needs of clients-duties and giving back a compensation said clients-investors.

This new kind of insurance permits a generalization of the concept ‘insured event’ thanks to a new kind of a marketing by traders of goods and services instead goods and services proper. It creates from more or less local known insurance services something much more important like ‘Insurance of Entire Society’ and gives said insurance a lot of new applications like tax privatization, ordering Medicaid, ‘Direct Democracy’ to initiate different private initiatives and ‘Marketing by Marketing’ to compensate defects of a regular market by advantages of a collective market.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to an insurance method, and system specifically to thereof based on at least two separate but related contracts belonging to one insurance plan. More specifically, it concerns taxation to be applied commercially like insurances. One more specifically, it concerns marketing by players of regular marketing.

It relates to current U.S. Classes 705/4, 705/36T, 708/163 and touches, accordingly, Insurance, Tax strategies and Business.

A known insurance method could be described by a contract between an insurance service and a client of this service to provide said client and/or a representative of said client with a financial support called cash value amount when an insured event happens like an illness, auto collision, a time period to expire in respect to said client or said representative of said client etc. In turn and in accordance with said contract, said client and/or said or another representative of said client pays said insurance service regular payments called premium amounts until said insured event happens.

Known insurance system could be described also like a financial unit connected with clients of said unit by means of two-sided communication to produce definite financial and/or banking operations in respect to said clients and to send/receive financial and other information to/from said clients.

Disadvantage of known insurance method, and system it deals in specific and/or force majored insured cases while many regular financial problems happen every day and wait for a legally secured contract kept by an insurance service to resolve or smooth said problems.

Said disadvantage takes place, among them, because known insurance method, and system combine administrative and partnership activities in respect to clients. It results in mixing together so different fiscal, treasuring and banking functions and helps known insurance method and system to get unjustified additional income for the cost of clients.

It creates a conflict of interests between said clients and known insurance method, and system. A great potential social power of insurance appears suppressed. It is why known insurance method, and system is unable to deal in variety of different financial problems.

Recent U.S. Pat. No. 5,752,236 ‘Life insurance method, and system’ from May 1998 splits a regular insurance plan into at least two separate but related insurance contracts. This novelty could be interpreted, in principle, like a method, and system to get with a financial service a fair arbitration among separate but related partners each one with own interest and a contract to keep said interest.

However, said U.S. patent implies serving the same client by many contracts. It reveals disadvantage of said patent. If a client keeps own specific unity, dividing an insurance plan of such client into separate but connected parts destroys said unity and helps more powerful commercial partner (like an insurance service) getting preferences for the cost of less powerful partner (like said client).

It could be shown by an example of a regular activity of Social Security Administration (SSA). SSA is a Federal Agency of U.S. to collect, among them, regular contributions of working people and employers of said people who pay SSA collectively so-called social security tax during entire working life of said people. In turn, SSA pays said people when they become old or disable so called ‘social security’ or a kind of retirement benefits.

Actually, SSA works in this aspect following a typical scheme of an insurance service. Collected by SSA social security tax payments, the same premium amounts, are stored on personal accounts of clients of this insurance service and correspondent retirement benefits, the same cash value amounts, are paid by SSA said clients when they become old or disable.

From other side, SSA is a part of a mechanism of taxation. It gives the ground to think entire taxation cold be interpreted like an insurance service. It opens the perspective to improve whatever disadvantages of taxation by an improved method of insurance.

Said U.S. Pat. No. 5,752,236 offers dividing a regular insurance plan into at least two separate but related insurance contracts. Said patent is in effect from May 1998. SSA has invented this ‘novelty’ many years before. It is realized by known program ‘Family Help’.

This practice is now contested by a family of clients of SSA, cases 7120 and 5383 (last four digits of social security numbers of plaintiffs). It touches just dividing a contract of a unity (a family) into two separate but related parts (for a wife and husband separately).

This concrete family is represented by two old and poor people (wife and husband with no one other member of the family in the country) when both ask each own retirement benefits while each member of said family could be still working at the time to ask retirement benefits.

SSA divides the family into two separate but related parts (wife and husband) to calculate retirement benefits in such a way each member of a family and entire family would get less benefits just due to said dividing. It is fulfilled by subtracting an essential part (30%) from regular retirement benefits of a husband as if to help his wife and by similar subtracting the same from regular retirement benefits of a wife as if to help her husband.

It is done even if the family does not need such ‘help’ and does not apply for this ‘help’ because said spouses live together, have a common budget, a combined banking account and pay tax like a family. It is done even there is no one person belonging to the family to live inside U.S. and to get said family help.

It is done before checking if a working wife is eligible to get her ‘family help’ and if a working husband is eligible to get his ‘family help’. It means, there is a guaranteed result: entire amount of social security help earned by said clients will be paid said clients never. An essential part of said social security will help SSA. Remember, 30% of social security amount of clients have already subtracted like ‘family help’ to appear on an account of SSA. Which is not paid clients is left of said account.

But there is an official decision to deny unlawfulness of which is said above. The decision is taken by The Honorable Administrative Judge of SSA Kenneth G. Levin from May 27, 2007, Social Security Administration, Office of Hearing and Appeals, 26 Federal Plaza, RM 29-09 New York, N.Y. 10278-0199, Tel (212) 264-8819/Fax: (212) 264-8633. As for the present invention, it is important to understand a financial surplus/loss could be gotten by a formal procedure (classification) to divide a unity into parts or to combine a unity from parts. Procedures of this kind look like getting something from nothing and are known thanks to practice mostly malicious.

The present invention is oriented to apply financial classifications positively. Look at taxation. People pay tax individually while a correspondent budget is collected in bulk. A resource of classifications is seen here. Taxation resembles insurance because tax is paid like a premium amount in terms of insurance. Satisfying collective duties of society by budget could be interpreted like an insured event. But no cash value amount is paid taxpayers back. If taxation is an insurance, it should be estimated like disadvantage.

But taxation is not an insurance. To estimate taxation like an insurance, it is the idea of the present invention only. Numerous other disadvantages of taxation are known without the interpretation. For example, when tax goes up, it is good for budgeting but is not good for developing business and commerce. When tax goes down, the pictures is turned up side down. It reveals an internal conflict of interests like a disadvantage of taxation.

Another disadvantage: there is no personal interest of taxpayers to pay tax. This situation creates many problems. Society appears divided into a creative part and a bureaucratic part to act by instructions. When taxpayers avoid paying tax, they act unlawfully but ‘creatively’. It is a disadvantage when initiative people are provoked to act unlawfully.

Budgeting and taxation, collective problems of society to be resolved by a budget, such aspects are under a strong administrative and political control but nothing essential happens in this sphere for years. It is a usual practice to explain the problem by a human factor. In result, every new political figure reorganizes something following common sense. The present invention attracts attention at the phenomenon of an unavoidable conflict of an advantage to appear a disadvantage at a time. However, this phenomenon is beyond common sense.

Creative commercial activity of people is oriented to be focused on successors. It goes against whatever efforts to scatter a focused success for the profit of different collective (social etc.) non profitable interests of not successors. It is a conflict which cannot to be avoided as such but could be adjusted to bring people positive results.

### BRIEF SUMMARY OF THE INVENTION

Tax insurance method, and system is offered to form an insurance plan combining together at least two separate but related contracts. It helps insurance providers to support different but related clients applying a legally secured united technology and, for example, to collect financial contributions of clients-investors, to satisfy financial and other needs of clients-duties and getting back a compensation said clients-investors.

This new kind of insurance permits a generalization of the concept ‘insured event’ thanks to a new kind of a marketing by traders of goods and services instead goods and services proper. It creates from more or less local known insurance services something much more important like ‘Insurance of Entire Society’ and gives said insurance a lot of new applications. The present invention offers four of them: privatization of taxation, putting in order financial processing Medicaid, ‘Direct Democracy’ to initiate different private initiatives and ‘Marketing by Marketing’ to compensate defects of a regular market by advantages of a collective market.

### BRIEF DESCRIPTION OF THE SEVERAL VIEWS OF THE DRAWINGS

In the drawings, closely related figures have the same numbers but different alphabetic suffixes

FIG. 1 illustrates prior art in respect to a taxpayer 10 who is obliged to pay tax for supporting a collective duty or duties 12 of society

FIG. 2A is a block diagram to show sandwiching a tax insurance unit 14 between said taxpayer 10 and said collective duty or duties 12

FIGS. 2B to 2D are diagrams to show the present invention splits into at least two separate but connected parts a financial pattern of a taxpayer 10 (16—to pay tax and 18—to get a compensation) on FIG. 2B, a unit of tax insurance 14 (20—controlling and insuring department, 22—banking and financial department) on FIG. 2C and a collective duty or duties 12 (24—maintenance to receive a financial support, 26—informational unit to report about supporting, 28—official representative) on FIG. 2D

FIG. 2E is a block diagram of the method, and system to realize said tax insurance in accordance with the invention herein

FIG. 3C is a block diagram of the method, and system to realize tax insurance of financial processing businesses like medical ones to serve Medicaid

FIG. 3A is a diagrams to show the present invention splits into at least two separate but connected parts a private business 30 to serve a collective non profitable duty paid by Medicaid (24—maintenance to receive a financial support, 26—informational unit to report about supporting)

FIG. 3B is a diagram to show the present invention is oriented to make a collective duty 12 (Medicaid) almost autonomous in respect to a private business 30 to serve this duty. Said duty 12 contains an official representative 28 of Medicaid to keep control functions

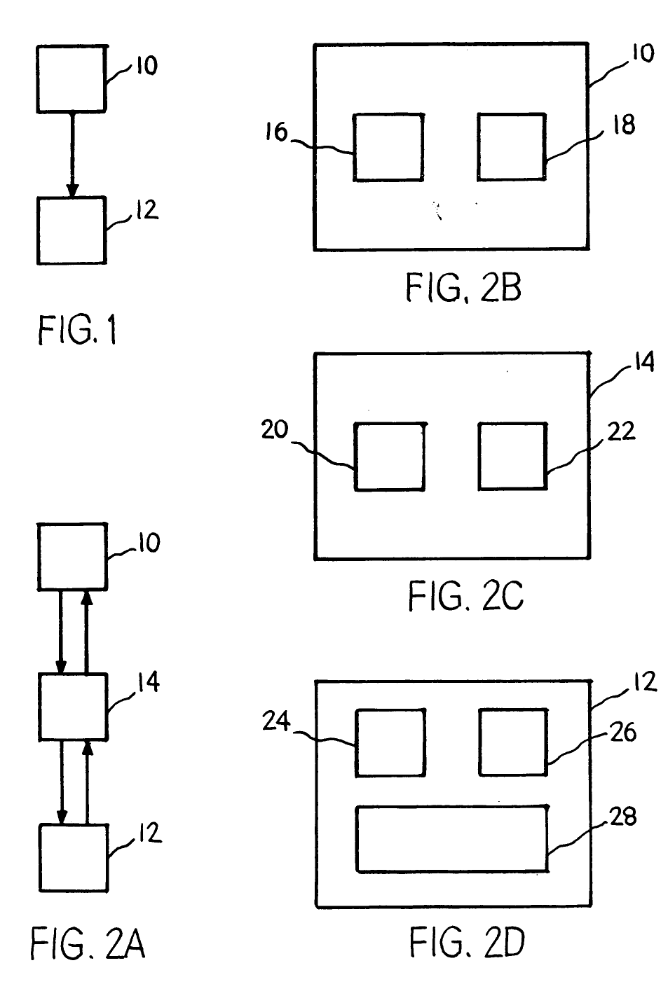

There are numerals in drawings. They are:
10 a taxpayer or patient (for Medicaid embodiment), a client of an insurance service
12 a collective duty or duties of society, another client of said insurance service
14 unite of tax insurance or a center of banking, insuring and financial operations
16 tax payment of a taxpayer (like premium amount)
18 income of a taxpayer (a compensation like cash value amount)
20 controlling and insuring department
22 banking and financial department
24 maintenance to receive a financial support
26 informational unit to report about supporting
28 official representative of a collective duty or duties 12
30 private medical business to serve Medicaid

### DETAILED DESCRIPTION OF THE INVENTION

The present invention offers a tax insurance method, and system for the next embodiments:

to privatize taxation;

to initiate different democratic collective initiatives (‘Direct Democracy’);

to optimize financial streams of private medical businesses to serve Medicaid;

to get marketing of players of a marketing (‘Marketing by Marketing’).

A philosophy of the present invention could be described shortly in such a way. The main source of prosperity (regular marketing) reveals a great success thanks to natural for people orientation of getting a private income. However, the same source defines a great failure: it does not work with non profitable deals.

It forces people to process non profitable deals administratively applying taxation. The fact is however administrative activity is left beyond sound competition. It is far as well from been the field of human initiative. It makes administrative activity non effective.

The present invention offers a tax insurance method, and system to play the role of a commercial mediator between administrative and marketing zones of society. This role of said tax insurance method resembles one of a transformer in a radio/electro technique to coordinate parameters of energy/signal between a sender and a receiver.

Purposing financial streams should be coordinated in the sphere of human relationship like electrical parameters are coordinated by said transformer and similar devices. It concerns a real conflict when taxpayers are constantly oriented to pay less while non profitable deals of society supported by payments of said taxpayers demand more and more financial contributions.

The present invention offers said tax insurance method like a commercial enterprise to serve said collective duties of society getting own income and an income for taxpayers. This plan is based on understanding there is an essential conflict of interests which could not be resolved as such, by a direct redistribution of financial streams. But said conflict could be resolved indirectly by strengthening commercial and shortening administrative efforts.

There is a theoretical conclusion on this theme of the author of the present invention: without taxation, it is impossible to improve taxation. Improving taxation should be based on a mechanism of taxation.

It looks like absurdity: the mechanism is offered to privatize taxation while it is called a taxation is demanded to privatize taxation. The point is taxation is demanded like a financial barrier which possesses serious algorithmic and financial possibilities. For example, the simplest arithmetic taxation (applied right now) algorithmically could be understood like shifting arithmetic zero (to count income or loss) into the zone of negative numbers.

It means, there is the possibility to take a commercial activity in the zone of non profitable deals or ‘below zero’ for getting an unusual ‘conditional’ income/loss giving in the case of a success taxpayers back a compensation of tax payments. By other words, a financial resource could be extracted actually ‘from nothing’ or from a scheme of financing only.

The plan of the present invention: useless bureaucratic elements of taxation should be shortened while useful algorithmic elements of taxation should be strengthened. There is a simple physical analogy to understand the idea: a dam on the river. Water before the dam and water after the dam both together and each one produce useful job.

In Nature, water goes down even without a dam. Correctly, just going water down forms a kind of a natural barrier to create useful circles of water transformation from powerful streams of water till so weak clouds on the sky.

Human society suffers from breaking financial circles. Financing should work in different phases of existence differently but all phases should be connected, not divided. It concerns profitable powerful streams of a regular market transformed into weak non profitable brooks. Said weak streams should be collected together for resurrecting into the same powerful streams. It is the way to resolve by a sound financing a lot of terrible human problems.

And what is more: each phase of financing demands own methods of processing. While strong financial streams work as if ‘by themselves’, weak financial brooks demand a special reinforcement. It concerns, for example, the embodiment of the present invention to put in order terrible administrative medical financing.

Each patient goes right now throughout a medical financial way with medical bills associated with said patient. The invention offers a financial conveyer to separate a patient from his medical bills. Let patients (except too heavy exceptions) are counted in bulk or by heads and let all medical bills of all patients are counted in bulk also. It would be good to deal in a budget.

What about medicine, it needs a detailed operational control. It could not be organized bureaucratically but could be realized commercially. It is the way to get more medicine for less money.

A tax insurance method, and system to privatize taxation is the main embodiment of the present invention to comprise the next steps:

providing multiple private and/or municipal and/or state and/or federal commercial enterprises or providers each one to go all the way from collecting some tax payments of some clients-taxpayers to transmitting said payments to some clients-collective duties of society and, maybe, producing managerial efforts to serve said duties;

establishing by a provider contracts with clients-taxpayers;

establishing by a provider contracts with clients-duties;

establishing by a provider a contract with authorities;

executing said contracts by said providers;

providing information about services fulfilled;

providing information about shares, fees, promotions and other financial conditions established by providers for clients;

providing potential clients with the right either to become or not to become clients or to discontinue the statute of a client.

More detailed, a contract established by a provider with a client-taxpayer comprises the obligation of said taxpayer to pay a provider even a part of own tax obligations for satisfying collective duty or duties-clients of said provider and following rules and regulations of said provider.

More detailed, a contract established by a provider with a representative of a client-collective duty or duties of society comprises common rules and regulations to serve said duties. Budget of said duty or duties should be fixed including expenses to keep evident and hidden bureaucracy around said duty or duties.

The right of said provider should be claimed to make from a part of entire tax stream created on the base of real payments of taxpayers an income of said taxpayers if said service appears more effective in comparison with administrative one.

More detailed, a contract established by a provider with authorities comprises allowances of taxpayers who pay tax a provider. It means, said authority take the obligation to accept said payments like official tax payments. It turn, said provider takes the obligation to inform authorities about actual tax payments.

The contract establishes also fees paid by a provider to produce audits and other external controlling activities of said provider. Penalties and fines to be imposed on said provider in a case of a violence of a contract are established as well.

All said contracts point out rights and obligations of a provider comprising fulfilling banking, financing, controlling and insuring operations with own clients, undoubted satisfying financial needs clients-collective duties inside limits of fixed budgets etc.

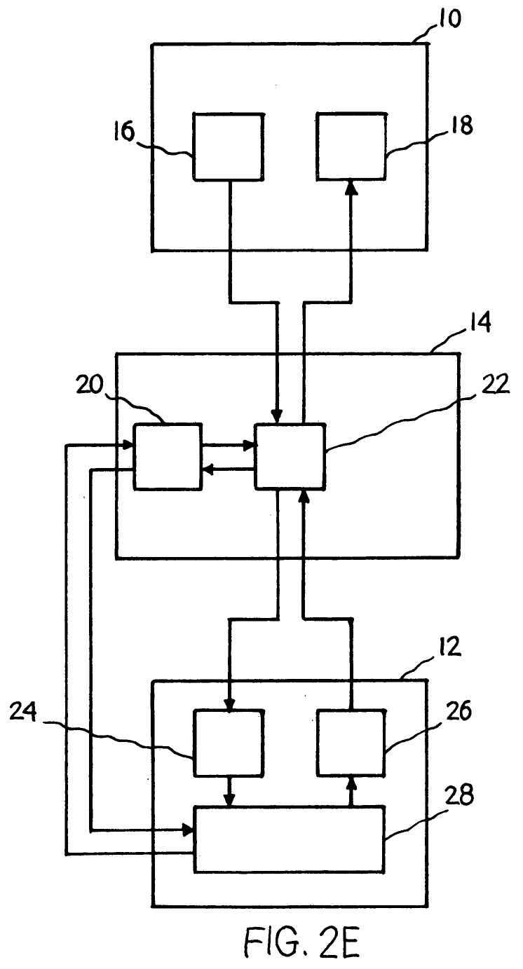

Diagrams and block diagrams of said provider are shown on FIG. 2 A to E. An apparatus 14 (FIGS. 2A, C, E) which is the center of banking, insuring and financial operations to realize said tax insurance method, and system, is sandwiched between a taxpayer 10 and collective duty or duties of society 12 by means of financial and other communication.

Said apparatus 14 is represented on FIG. 2C comprising controlling and insuring department 20 and banking and financial department 22. Said taxpayer 10 is represented on FIG. 2B comprising own tax payment (premium amount) and possible income 18 (cash value amount). Said duty or duties of society 12 is/are represented on FIG. 2D comprising maintenance to receive a financial support 24, informational unit 26 to report about results of supporting said duty or duties and an official representative 28 of said collective duty or duties to control satisfying said duty or duties.

Means of communication are established between said representative 28 of said collective duty or duties 12 and said controlling and insuring department 20 of said apparatus 14, which is the center of banking, insuring and financial operations to realize said tax insurance method, and system.

It is supposed however said apparatus 14 is definitely sandwiched between said taxpayer 10 and said collective duty or duties 12, if and only if said taxpayer 10 is definitely a client-taxpayer of this tax service and said collective duty or duties 12 is/are definitely a client-duty or duties of this tax service and correspondent contract are definitely established with said client-taxpayer 10 and a representative 28 of a client-duty or duties 12 and said provider.

FIG. 2E is to show that a computerized apparatus 14 is applied to process banking, financial, controlling and insuring operations comprising receiving tax payments 16 of said taxpayer 10 and supporting financially collective duty or duties of 12, which includes, among them, opening and keeping accounts of said clients and controlling activities produced by said tax insurance unit 14 under taxpayer 10 separately and collectively, in cooperation with representative 28 of collective duty or duties 12.

On said Figs, all communications are two sided. It is a technical attribute of an insurance service. Said communications comprise:

a financial channel to transmit tax payments of a taxpayer 10 to a banking department 22 of tax insurance unit 14;

a financial channel to transmit a compensation from said department 22 to said tax payer 10;

a financial channel to transmit a financial support of said tax insurance service from its banking department 22 of unit 14 to maintenance 24 of collective duty or duties 12;

an informational back channel from an informational unit 26 to report about supporting duty or duties 12 to banking and financial department 22 of said tax insurance unit 14;

an informational two sided control channel between said representative 28 of said duty or duties 12 and a control department 20 of said unit 14.

What about said income or a compensation of a taxpayers, it is the novelty of the present invention. But it is not an obligation. It is a possibility which depends on a commercial and managerial skill of a provider as well as a chance to get an occasional success.

It is a usual commercial practice. In this aspect, the present invention does not go beyond known commercial borders. Every commercial success is based on a skill and chance. But to apply said skill and to get a chance, conditions should be prepared. In the present invention, said conditions comprise:

a provider could serve a client-duty or duties more effectively than a bureaucratic administration does; wherein makes an income from the difference between expenses established by a budget and actual expenses of said provider; said income may be distributed proportionally among clients-taxpayers of said provider;

a provider could serve a client-duty or duties more effectively than another similar provider does; it gives said provider the possibility to recruit better clients, to establish a higher price to become a client, to issue more expensive shares of own business etc.; shortly, it is the possibility a provider could become more or less costly in comparison with other similar providers.

For example, a provider could recruit like own clients-taxpayers employees of own clients-duty or duties as well as administrative bureaucrats to deal in said duty or duties. It is the way said employees-clients and bureaucrats-clients would serve correspondent duties keeping own commercial interest with the hope to get more compensation back.

It is a human factor to improve a terrible situation when who is fed by a budget asks more and more money while who creates said budget by own efforts (a taxpayer) ask paying less tax. The present invention puts a taxpayer inside budget expenses to stop this practice.

So, an amorphous field of taxation appears divided into zones of almost independent financial, commercial and managerial activities thanks to the present invention. In terms of a physical analogy, taxation looks like a dam on the river when entire stream of water after the dam is divided thanks to the present invention into separate but related parts to create which is absent in taxation right now but takes place in Nature: returning even a part of entity (water, money) after the dam back on the level before the dam.

Naturally, it is done by seasonal evaporation of water into clouds with further rains to pour said water out on the ground. The present invention offers an artificial commercial and financial mechanism to produce a similar activity artificially and to return even a part of a financial resource back for a profit of taxpayers. It is the way to prevent people from exhausting society that could be completely eaten soon or later by own bureaucracy.

What about providers, they would be satisfied by processing huge financial streams of taxation and applying known financial tricks executing said processing. What about clients-duties of society, they would be served better thanks to a competition among providers. It shows the present invention does not create conflicts of interests. It would bring profit all participant of the scheme realized by the present invention.

Let understand however, without a financial barrier (like a dam on the river) in any form, for example—in the current form of a simple arithmetic taxation, no financial circling is possible in the zone of non-profitable deals to speak nothing about getting a compensation like a paying back in response to an actual paying tax.

It shows the present invention reveals an unknown before phenomenon of creativity of a barrier, contrast, contradiction etc., here—a financial barrier—to be applied in said embodiment to privatize taxation even partially and to get taxpayers a compensation of own tax payments.

By other words, duality of a barrier (conflict, contradiction, taxation) is revealed. It means, which is so evident as necessity to fight against taxation and against associated bureaucracy covers only a part of the problem of taxation. Another, it is not excluded, the most important part of the problem of taxation concerns a new invisible possibility of business and commerce to create financial circles to pay tax and to get money back overcoming different financial barriers by internal marketing under said barriers and, it is so important—leaving a partner of said process beyond or almost beyond said circling.

It denotes a potential possibility to get autonomous partners to pay no tax and to get no additional income but to get a payable service. It is the way to create a minimal social medicine for free, minimal other social deals for free etc. It is a potential way to resolve numerous social problems by effective capitalism. It is the way to get socialism by capitalism. Embodiment of the present invention to step on this theme see below.

At the current embodiment to privatize a regular taxation, a market of providers is created to compete each others recruiting clients and serving said clients in accordance with skill, success and other creative and commercial factors.

If information about all providers is distributed on said market, it would result in a financial estimation of said providers. Who works better becomes costly and has the possibility to realize own value by known financial instruments like shares, assigning a price to become a client of own service higher than who is worse and costs cheaper etc.

This picture could be interpreted like appearance of a financial environment differ from thereof on another side of a financial barrier created by taxation. Taxpayers pay tax to satisfy concrete collective duties while providers of said service compete each others to win a competition on a market of own servicing.

Another look at said embodiment, it resembles insurance+investments. Which is paid by a taxpayer like a tax payment could be understood as a regular premium amount but while it is transmitted to satisfy collective duties of society, it looks as an investment of said taxpayers. At the same time, which is transmitted to satisfy collective duties of society looks like a cash value amount paid by said tax insurance service another client of said service.

This scheme does not give said tax insurance service the possibility to apply money of clients for getting own income. But there is the possibility to get income indirectly thanks to processing financial streams of clients.

It makes said tax insurance service financially independent from own clients. In terms of insurance, it avoids specificity of an insured event. Now only serving clients is the event to be insured. It means, a provider could serve whatever duties and to apply whatever financial and managerial skill independently from the essence of a duty.

Which is done appears an extended insurance because legally secured contracts are established by said service to produce an activity and to insure this activity independently from a probability of an insured event, necessity to take money of clients etc.

Getting own income independently, said tax insurance service could serve interests of own clients like a fair financial partner the more so as an additional income is possible to bring taxpayers a compensation thanks to a) the possibility to serve duties better than it is done bureaucratically and b) to do this better than it could be done by other providers.

Advantages of this approach in respect to insurance:

insuring regular (everyday) events instead of exceptional events;

been a banking, financial and informational center to keep legally secured contracts and, for example, to receive tax payments and satisfy by said payments duties of society;

providing taxpayers with a financial and/or moral compensation of own payments;

staying beyond fiscal and treasuring function in respect to own clients.

It brings common advantages:

to get even partial privatization of taxation;

to take a commercial activity on the place of repressive taxation;

to get advantages of competition in spheres of taxation and applying budget money;

to provide more efficiency and quality of serving collective duties;

to influence collective sphere beyond bureaucracy or getting ‘Direct Democracy’;

increasing the interest of people to support collective duties;

smoothing criminal activity around taxation;

shortening the army of administrative bureaucracy;

smoothing corruption of said bureaucracy;

It is done thanks to some novelties of the present invention in respect to taxation and budget distributing:

permitting independent commercial providers to support collective duties of society;

providing people with free choice to pay tax for supporting definite collective duties;

exact addressing financial streams paid by people to support collective duties;

providing people with a financial compensation of paying tax;

permitting providers to apply the difference between budget defined expenses to support a duty and actual thereof to compensate official tax obligations;

permitting marketing on the level of serving collective duties;

permitting providers establishing fees and promotions for clients of said providers;

Said novelties create an operative diversity inside amorphous up to now sphere to collect tax payments, to form a budget and to distribute said budget among numerous mostly non profitable collective duties. It comprises a multiple choice among providers, taxpayers and collective duties and defines a competition among all participants of this activity.

The next embodiment of the present invention concerns initiative possibilities of people and group of people to support whatever collective ideas. In a democratic society, every citizen could take every initiative but to organize a valuable collective movement, it costs more money. It reveals a financial barrier not to be overcome by a single person who decides to influence something but cannot pay money to organize thereof. Society does not need this barrier. On the contrary, society needs freedom of valuable democratic initiatives.

The present invention offers the same tax insurance method, and system to support whatever initiatives of clients-taxpayers. Each client-taxpayer could make an additional payment addressing this payment on the base of patriotic, political, cultural or any other ideas.

The payment appears on a special account opened by a correspondent provider. The initiative appears on the list of initiatives published by said provider. The longer is the list of collective initiatives announced by a provider, the more is the interest attracted to this provider by a common market of collective initiatives. It helps recruiting new clients ready, among them, to support initiatives of said provider.

For example, an initiative could support a political figure virtually, by money on an account of a client-taxpayer or taxpayers not paid to anybody. It is the case not paid amounts of money could work better than special polls. The point is it is good for everybody because this embodiment helps spreading ideas among people without any corruption and/or political speculation. The author calls this embodiment ‘Direct Democracy’.

The next embodiment of the present invention is offered to put in order financial streams around businesses like private medical services to cure poor patients of the medical programs like Medicaid paid by budget. Ideas of this embodiment may be applied in other kinds of medical services and businesses to serve collective duties of society paid by budget.

The main peculiarity of businesses to serve Medicaid they are paid by a budget paying own tax payments to fulfill said budget. It makes from said businesses double clients of said tax insurance providers: clients-actual duties of society that need to be paid by a budget and clients taxpayers to support said duties by own tax payments even partially.

It gives said tax insurance method, and system the possibility to serve said businesses making first steps on the way to get autonomy of said services from a budget and putting all other taxpayers of society into the position of ‘invisibility’ in respect to said service. It could be just a fantastic medical service completely paid ‘by itself’ to serve for free which is beyond said autonomy or financial circling.

Combining two contradicted financial streams together (which should be paid by a budget for a service and tax payments in accordance with income gotten), it is too hard for tax/budget bureaucracy. As for said tax insurance service offered by the present invention, it could be easily realized. There is no financial revolution in this achievement but a bit of budget expenses could be saved. Why not to do this?

The point is there are many ways to get an additional income by developing more effective technologies of private medical services paid by budget by programs like Medicaid. But independently from ideas involved to get said achievements, private responsibility for said achievements could be realized much more faster and effectively than whatever administrative reform with a lot of political discussions and speculations about everything but said technologies.

It explains why the embodiment to serve private medical businesses paid by Medicaid is represented in the present invention like a dependent claim in respect to the main claim concerning said tax insurance method, and system.

Commercial grounds of said tax insurance method, and system are close to thereof said private medical services. It makes them partners without a conflict of interests because efficiency of said medical businesses appears profitable for both said medical services and said tax insurance method, and system.

Under a bureaucratic control, a medical business is oriented to get as much financing of a budget as possible. It happens because a technology of said medical business is beyond interests and attention of said bureaucracy. But under the control of a commercial provider, said medical business would become as effective as possible to get additional profit which cannot be gotten by a budget, only by effectiveness.

In commercial hands of said provider, effectiveness of a client will bring an additional income. This income will be gotten on a market of similar providers. So, unity of private interests of a provider and its client opens a commercial stimulus to deal in effectiveness of said client.

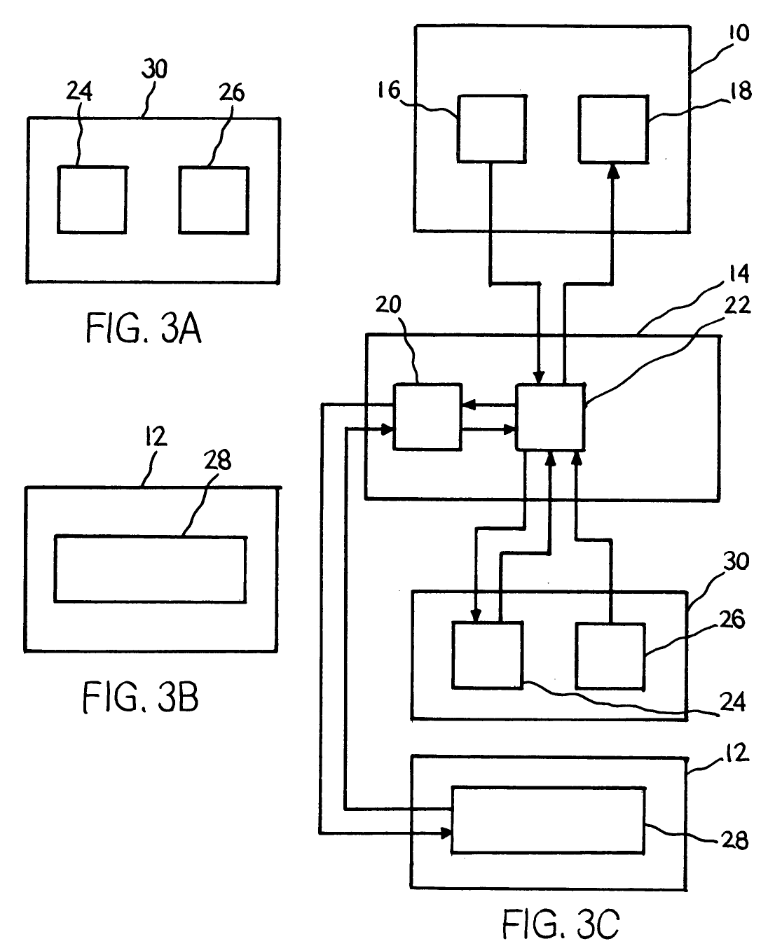

On the FIG. 3 A to C, diagrams and block diagrams are represented to put a medical business under the control of a tax insurance provider offered by the present invention. On the FIG. 3A a medical business 30 to serve Medicaid is shown like an actual collective duty which needs a financial maintenance 24 and is ready to inform a provider 14 about own job by an informational unit 26. It is important to notice: said medical service 30 is paid by said unite of insurance 14 directly and by a budget—indirectly, by efforts of said tax insurance service.

On FIG. 3C, said medical service 30 is shown connected with said insurance unit 14 while said insurance unit 14 is collective with an official representative 28 of Medicaid like a collective duty 12 of society paid by budget.

It reflects practice of Medicaid. This service does not provide a medical service. It provides a bureaucratic service only. It explains different discrepancies between real and virtual parts of Medicaid. The present invention is called to avoid said discrepancies.

The novelty of the present invention, bureaucracy 28 of Medicaid is connected, as it is shown on FIG. 3C, with tax insurance unit 14 to touch mostly financial, not medical aspects. It helps private but real medicine to communicate with a private financial service 14 resolving a common task to increase efficiency independently from a budget.

It helps also said private financial business to communicate with said budget resolving common task of this level—to save budget just financially, not medically and do not mix so different task together.

By other words, different improvements inside the pare ‘medical service—tax insurance provider’ will be fulfilled beyond attention of bureaucracy of Medicaid, even beyond approval of this bureaucracy.

For example, said tax insurance provider can recruit clients-taxpayers from both groups of people involved into the service of Medicaid: employees of own double client-private medical service and bureaucracy of an administrative part of Medicaid. It is shown on FIG. 3C where a taxpayer 10 is connected with said unit 14 of insurance.

It is the way to improve the situation in at least two different directions. Firstly, an amount of tax payments connected with a medical service increases to satisfy better a private medical service, a double client of said tax insurance provider.

It makes said private business less dependent on authorities or, the same, more autonomous in respect to budget bureaucracy. It means, a financial freedom increases of the pair ‘provider-executor of medical service of Medicaid’. Secondly, responsibility increases of people involved into this service to do own work better because the hope appears to get additional income resulted from said better job.

The present invention offers also an improvements as a financial conveyer which resembles one invented by Ford to make automobiles by operations, not entirely. Which takes place right now, it is just ‘production of health’ entirely when a patient goes all phases of curing with all medical bills associated.

Medicaid keeps the classification to combine together a patient and his medical expenses like all other medical services of U.S. do. It has sense for exceptional circumstances like extremely heavy patients. But it has no sense in ordinary conditions because a) every ordinary patient of Medicaid should be undoubtedly cured and b) to count personal medical expenses of every patient, it is unnecessary and it costs much more in comparison with a conveyer wise technology to fix attention on operations and count common financial results in bulk.

So, much more sense has the technology to count all patients of a double client or clients of a concrete tax insurance provider of Medicaid ‘by heads’ or in bulk and to count all medical expanses of said patients also in bulk to speak nothing about rare exceptions. It helps to establish an average rate of expenses demanded to cure an average patient of Medicaid and to control budget expenses more cheaper cutting off a part of bureaucracy of Medicaid. It helps not to touch medicine controlling effectiveness of private medical businesses on the level of the pair ‘provider-representative of Medicaid’.

Another program is demanded to get real effectiveness of a private medical business. It demands a detailed operational organization of a correspondent medical technology. It could be the activity on the level of the pair ‘tax insurance service-private medical service’.

Said tax insurance service would not touch a medical aspect but it should touch a financial aspect and should do this in respect to a single medical operation. For example, such factors should be taken into account as average usage of equipments, qualification of personal, cost of said operation etc.

Patients of a medical service will prove the technology by own participation. Too many patients or too less patients per a technological element would attract attention like a signal to improve a situation.

In general, it is not a medical business. It is not a business of a budget bureaucracy as well. It is the business to cure medicine from a financial illness as the lost of productive effectiveness. It is a managerial and financial deal to be done by said tax insurance service or a special service to be hired in order to organize properly every element of said technology.

Many great political figures think on the theme what to do with growing medical budget expenses. But they think abstractedly. In result, nothing is done in this domain to put a medical technology in proper order following ever simple and known technological tricks.

On FIG. 3C, it is shown that managerial block 24 of medical business 30 is connected with the block of banking and financial operations 22 of a unit 14 with means of two sided communication. It shows incoming and outgoing financial streams of said private medical service are met together in said insurance unit 14 to resolve all financial problems on commercial grounds and beyond a budget administration 28.

If said technology is applied, medical services would get the perspective of a financial freedom. A tax insurance provider takes a credit in budget to pay own double client or a private medical service a part of its annual expenses. Another part should be mobilized by said private medical service on the base of own resources because it is much more expensive to pay tax and to ask budget payments ‘by patients’ or by little portions proving said payments ‘by current troubles of a current patient’. This technology is absolutely ridiculous. It looks like buying an automobile ‘by its parts’.

Instead, said tax insurance service draws a model of an average patient of Medicaid to control an everyday activity of own double client-said private medical business in accordance with this model. The task of said representative 28 of Medicaid is to control common budget expenses following the same model of an average patient and by current data given by said tax insurance service.

So, there are at least two ways to improve financing private medical businesses paid by Medicaid and to get an additional income:

shortening bureaucracy of Medicaid;

improving technological efficiency of private medical services.

To go this ways systematically, a mediator like said tax insurance provider is demanded to realize two different but connected task: to estimate medical financing in bulk for budgeting coordination and to estimate medical technologies by productive elements for getting financial effectiveness of medical businesses.

Additional financial resources would be gotten on a common market of private medical businesses to serve Medicaid comprising the steps:

competition among similar providers by common parameters of quality of serving;

competition among similar providers for serving more patients for less price;

competition among similar providers for the cheapest average patient;

competition among providers to get more clients-taxpayers;

competition among providers to get more double clients-private medical services;

Advantages of said embodiment:

giving private initiative more financial freedom in the sphere of Medicaid;

applying said freedom to increase financial efficiency of a medical serving;

applying said freedom to simplify interactivity with a budget;

making said private initiative almost autonomous in the sphere of Medicaid;

combining incoming and outgoing financial streams of Medicaid together;

improving efficiency of financing a medical business to serve Medicaid by counting separately and in bulk patients and common medical expenses to cure said patients;

controlling a financial situation in respect to the variety of elements of a medical technology.

increasing responsibility of private medical servicing paid by a budget for own financial discipline by prizing them by an additional income;

decreasing actual budget expenses.

The embodiment ‘Marketing by Marketing’ of the present invention is based on a model to make visible hidden similarity of so different parts of society as regular marketing and political-administrative efforts to deal in budget for the cost of taxation. In result, said political-administrative efforts are understood like an alternative option of regular marketing. Both have own advantages and disadvantages but said advantages compensate said disadvantages only partially.

The idea of the present invention which is between said ultimate limits (intermediate options) could be constructed with more appropriate advantages and disadvantages to get better common compensation.

The embodiment ‘Marketing by Marketing’ comprises some steps and which is called ‘establishing a barrier’ is the first one. The term ‘barrier’ in the case of marketing implies a difficulty or an obstacle or a problem to be met during a commercial activity. An evident obstacle—a financial barrier. Many difficulties on the way of business and commerce are known and discussed but uncertainty of said barrier. This problem is beyond attention.

Un-balancing of regular marketing is known. Effectiveness, great richness of some players is accompanied on said market with bankruptcies, other failures. It results in poverty of many people, other social troubles. This phenomenon of regular marketing is explained usually by a human factor. The present invention leaves said factor beyond attention.

The point is involving said human factor makes the problem of marketing hopeless. People hardly could be reconstructed and improved in any way. The present invention attracts attention at uncertainty of numerous barriers inherent in regular marketing.

This approach is much more technological because uncertainty, in principle, could be substituted by more or less certainty. However, absolute certainty is not necessary on a market because uncertainty helps hope and supports initiative. A human being may to mobilize herself or himself and own creative possibilities: imagination, initiative etc.

Taxation is an example of an excellent certainty of a financial barrier to be overcome by tax payments established officially. The peculiarity of taxation other commercial barriers are completely absent because people take no commercial efforts in taxation. On the contrary, people are forced to pay tax administratively. A psychological barrier is created in turn on the base of the wish not to pay tax.

So, political and administrative efforts to get a budget fulfilled by taxation could be interpreted like an ultimate ‘market’ with fixed financial barriers, absence of commercial activity and a psychological orientation of taxpayers not to deal in this ‘market’ at all. It results in ultimate non effectiveness of this ‘marketing’.

This interpretation leads to concrete and practical ideas oh the theme that a technology of marketing engineering may be developed. The embodiment ‘Marketing by Marketing’ is constructed like the first step of said technology. Which is positive in budgeting and taxation is applied to compensate by a correspondent hybrid of marketing which is negative in regular marketing and vice versa.

Definite financial barriers established by official tax regulations could be estimated like a positive trait to strengthen stability of a market. Unavoidable appearance of players on this ‘market’ (taxpayers and duties of society) could be estimated as another positive trait to strengthen stability of a market. Yet another positive trait of said zone of budgeting by taxation—non profitable deals are processed actually even if non effectively.

It is realized administratively, not commercially and it is a negative trait of said administrative zone. People are not purposed commercially on this ‘market’. Without proper purposing, a factor of psychology kills human initiative and makes all political and administrative efforts in budgeting by taxation extremely non effective.

On the contrary, a regular market is purposed excellently but just because this said market appears extremely non stable. The purpose to get income may overcome quality of goods and services, other reasonable circumstances. It results in many unexpected events to happen on said market.

Great commercial purposing on said regular market could be estimated positively and negatively at a time. It is because said purposing leads to great effectiveness to deal in profitable deals and simultaneously, to zero effectiveness to deal in non profitable deals.

The conclusion: positive and negative traits are scattered together. It makes senseless the task to resolve whatever problem finally. The present invention is oriented to deal in the technology to smooth a problem by another problem and, for example, to compensate defects of a market by advantages of another market and vice versa. Constructing a chain of positive and negative traits of marketing appears a technical, not political problem.

Which is said above could be interpreted in such a way a step of said technology has already done by people absolutely without understanding of which happens. Because said regular market is just compensated by administrative efforts to get budgeting by taxation.

The pair ‘regular market-budgeting/taxation’ looks like a specific conflicted unity. It opens the perspective to sandwich inside said ultimate limits the number of intermediate options.

The embodiment ‘Marketing by Marketing’ offers an intermediate market as a building with at least two floors. Commercial activity to sell and buy real articles and services is left on the first floor of the building while the second floor is occupied by an unusual market to sell and buy sellers and buyers situated on the first floor.

Said sellers and buyers appear specific goods and services to be sold and bought by said sellers and buyers for own profit. It is the way to get an artificial commercial purposing when there is no real commercial purposing.

This invention is realized by establishing:

a barrier to be overcome by investors thanks to payments and/or other contributions;
a duty or duties able be multiplied in society;
private and/or municipal and/or state and/or federal commercial enterprises or providers to take said investments and to satisfy said duties.

Further steps comprise recruiting clients-investors and clients-duties by said providers and establishing by said providers contracts with said client-investors and said clients duties.

It comprises the obligation of said clients-investors to make investments on accounts of said providers and the obligation of said providers to satisfy said clients-duties by said investments.

Said providers should establish contracts with authorities concerning mutual rights and obligations to be kept by said providers and said authorities comprising permission of free and/or licensed kinds of financial and other activities of said providers among own clients-investors and clients-duties, marketing by investors and duties, distributing possible income among clients. During executing said contracts said providers collect relevant information and spread thereof among population.

This scheme represents a generalization of the embodiment ‘tax insurance method’ of the present invention. It implies duties to be established by authorities in respect to non profitable obligations of society to be supported by taxation along with whatever duties created among both profitable and non profitable deals.

A financial barrier of said embodiment implies a bureaucratic barrier of taxation as well as whatever initiative barrier to be established by a constructor of a commercial scheme specifically in respect to a concrete task to be resolved on a market.

It makes from said embodiment an instrument to deal in long term aspects of taxation as well as more or less temporal problems to happen around regular marketing. This generalization is oriented, among them, to involve into marketing entire population of a country.

Taxation just involves entire population into official ‘marketing’ forcing people to support permanent non profitable duties of society. The embodiment Marketing by Marketing involves people to deal in problems of regular marketing also but applying the same united mechanism of a generalized ‘taxation’ which could bring profit.

The embodiment involves population to deal in whatever duties with the chance to get income by something like trading themselves like potential clients of providers to realize a real trade activity on said internal market. What about said market, it would become stronger the more duties are processed on said market.

The present invention offers strengthening said market by varying financial barriers. It may be done purposely/occasionally or alternatively. To explain this offer, a physical analogy could help. It concern electrical current, which is known in direct or alternative forms.

Direct current DC consumes energy directly. Occasional or random variations of DC are applied to adjust electricity to a consumer but energy is consumed accordingly. Alternative current AC is constructed to apply contradicted possibilities of capacity and inductance to take and to give back even a part of energy represented in correspondent forms. It makes AC more effective in some applications.

Attributes similar to formal inductance and capacity are inherent in people. The simplest examples: people create children to get new generations of people, people make good deals to get back new good deals etc. Such processes wait for contradicted markets to be switched from one to another either automatically or by an external signal to produce just varying a barrier, for example, a financial barrier to enter a market.

At least, the present invention offers creating financial streams to overcome financial barriers and to compensate expenses connected with this overcoming by a compensation gotten by trading clients and providers on said internal market of the second floor. It is the way to get dynamically so called zero-client of said providers who pay money for overcoming a barrier but get compensation for balancing said payments into zero.

It is the way to resolve social problems on the base of formal methods: by financial circles to bend different groups of population around virtually or dynamically by applying financial streams proved mathematically and realized on the base of different kinds of said internal ‘Marketing by Marketing’.

Advantages of said embodiment, it makes from the scheme of repressive taxation a valid financial instrument to deal in much more wider scope of marketing, financial, political, social and other human problems. It could be done thanks to a collective attribute of the embodiment ‘Marketing by Marketing’.

Monopolization of such market on the level of investors and/or duties has no sense because income on said market is gotten from diversity of said investors and duties created by applying a barrier to be overcome differently. In this model monopolization is equal to complete avoiding the barrier to kill said internal marketing.

Formally monopolization is a kind of focusing. The present invention makes which is focused by regular market scattered among investors/duties on a collective or internal market and vice versa.

For example, a current problem of regular marketing not to pay long term debts is extremely focused right now by said regular market. This focus may be scattered and compensated if to apply the present invention and to realize said scattering on a collective market involving all taxpayers (entire population) to deal in properly constructed ‘duties’ able to bring people income of such marketing.

The possibility to serve non profitable duties dynamically, by financial streams with internal barriers to be overcome by payments of people compensated later by an internal marketing under the same people replaces resolving terrible social problems of human society into the zone of a mathematical and physical interest.

I claim:

1. A tax insurance method for privatization of taxation comprises the next steps:
providing multiple private and/or municipal and/or state and/or federal commercial enterprises or providers each one to go all the way of own local taxation comprising:
recruiting collective duties of society like clients-duties of said providers;
establishing contracts with said clients to keep mutual rights and obligations comprising:
taking obligation to keep banking, financing and controlling operations;
fixing current budgets of said duties;
taking obligation to satisfy said duties financially;
recruiting taxpayers like clients-taxpayers of said providers;
establishing contracts with said clients to keep mutual rights and obligations comprising:
taking obligation to keep banking, financing and controlling operations;
fixing obligation of said clients to invest money like tax payments;
fixing amounts said clients to suppose paying like tax payments;
taking obligation official allowances would be applied in respect to said payments like tax payments;
taking obligation to pay said clients compensations of said payments to be gotten from definite kinds of income;
establishing contracts with authorities comprising:
taking obligation to keep common rules and regulations;
getting an agreements about tax allowances of clients-taxpayers;
getting an agreement about taking like income a part of tax payments of said taxpayers equal to the difference between said current budgets of said duties and actual payments to support said duties;
paying by said providers fees for audits and other controlling function in respect to said providers;
paying penalties and fines for a violation of said contracts;
issuing rules of own financial conduct comprising:
satisfying clients-duties financially as effective as possible;
issuing financial instruments to trade by own business like shares etc;
marketing by said instruments;
establishing fees and/or promotions for becoming clients;
sharing income gotten thanks to activities above with own clients;
executing said contracts comprising:
following common rules and regulations and established obligations;
collecting financial streams of clients-taxpayers;
addressing said streams to support said clients-duties;
collecting information about own job;
announcing said information;
marketing by own clients and own financial instruments;
recalculating financial documents, accounts and instruments comprising shares, fees and/or promotions for becoming clients etc;
sharing an income among clients-taxpayers proportionally.

2. A method of claim 1 for permitting said providers to take managerial and other non financial efforts serving said clients-duties.

3. A method of claim 1 for providing said taxpayers freedom of will to become or cancel the statute of a client of a provider.

4. A method of claim 1 for permitting said clients-taxpayers to invest voluntary payments associated with arbitrary patriotic, political, cultural etc. reasons.

5. A method of claim 4 comprising collecting said investments on special accounts, setting on said accounts the will of investors, publishing correspondent reports and announcements and executing said will of said investors.

6. A method of claim 1 wherein said provider recruits a private medical business or businesses to deal in Medicaid paid by budget like own double client one a client-taxpayer and another a client-actual executor or executors of Medicaid.

7. A method of claim 6 wherein establishing an agreement with a representative of Medicaid further comprises computing a budget or budgets of said double client or clients on the base of summarized parameters further comprising computing separately patients in bulk and medical expenses to serve said patient also in bulk.

8. A method of claim 6 wherein establishing a contract with said double client or clients-actual executor or executors of Medicaid further comprises representing a detailed description of a technology to serve said Medicaid, indicating qualification of a personnel and average load by patients of Medicaid of every step of said technology and correspondent equipments.

9. A method of claim 6 wherein establishing a contract with said double client or clients-taxpayer or taxpayers further comprises calculating a credit to be taken from a budget by said provider to satisfy financial needs of said double client or clients equal to the difference between an estimated budget of said client or clients and estimated tax payments of said double client or clients.

10. A method of claim 6 further comprising preferable recruiting by said provider employees of said own double client or clients as well as thereof belonging to bureaucracy of said representative of Medicaid.

11. A tax insurance system to privatize taxation comprising:
multiple private and/or municipal and/or state and/or federal commercial enterprises or providers each one to go all the way of own local taxation each one comprising:
a unite of insurance including data processing apparatus;
means connected to said apparatus for inputting instructions;
said apparatus having regulatory requirements of taxation and budgeting stored therein;
inputting instructions in said apparatus to produce banking, insuring, financing and controlling operations as well as calculating and recalculating financial requirements and other parameters;
inputting instructions is said apparatus for establishing contracts with clients-taxpayers;
inputted instructions is said apparatus for establishing contracts with clients-duties;
inputting instructions in said apparatus for establishing contracts with tax and budget administration;
inputting instructions in said apparatus to execute said contracts;
inputting instructions in said apparatus to compare executing said contracts against said regulatory requirements of taxation and budgeting;
means connected to said apparatus to execute said instructions comprises:
unit of insurance to produce banking, insuring, financing and controlling operations;
means to receive payments of said clients-taxpayers and send them income;
means to send a financial support said clients-duties;
means to compute the difference between a budget and which is actually paid to satisfy said duties;
means to produce banking operations to distribute said difference among clients-taxpayers proportionally;
means to recalculate own financial parameters;
means connected to said apparatus to communicate with representatives of said clients-duties;
means connected to said apparatus for displaying current results of own servicing;
means connected to said apparatus for announcing and marketing own servicing;

12. A system of claim 11 wherein supporting initiative activity of clients comprises inputting instructions in said apparatus to keep special accounts of appropriate initiative payments, fix setting of said payments, publish correspondent reports and announcements and execute real payments and/or other activities in accordance with the will of said clients.

13. A system of claim 11 wherein establishing said contracts to serve by a provider of a private medical business or businesses to deal in Medicaid paid by budget comprises inputting instructions in said apparatus to establish a united contract with a double client or clients as a taxpayer or taxpayers and the same client as an executor or executors of said Medicaid.

14. A system of claim 13 wherein establishing by means of inputting instructions in said apparatus a contract with a representative of Medicaid comprises means to compute a budget or budgets of said double client or clients on the base of summarized parameters further comprising computing separately the quantity of patients in bulk and the amount of medical expenses to serve said patient also in bulk and computing a correspondent tax.

15. A system of claim 13 wherein establishing said contract with said double client or clients-executor or executors of Medicaid by means of inputting instructions in said apparatus further comprises means to deal in a detailed description of a technology to serve said Medicaid, indicating qualification of a personnel and average load by patients of Medicaid of every step of said technology and correspondent equipments.

16. A system of claim 13 wherein establishing by means of inputting instructions in said apparatus said contract with said double client or clients-taxpayer or taxpayers further comprises means to calculate a credit to be taken from a budget by said provider to satisfy financial needs of said double client or clients equal to the difference between an estimated budget of said client or clients and estimated tax to be paid by said double client or clients.

17. A system of claim 13 further comprising inputting instructions in said apparatus about preferable recruiting by said provider employees of said own double client or clients as well as thereof belonging to bureaucracy of said representative of Medicaid.

18. Method of marketing comprising the steps of:
establishing a barrier like a tax obligation to be overcome by investors thanks to payments and/or other contributions;
establishing a duty or duties to be dispersed in society or a part of society to be served by contributions of many people like a collective duty of society;
establishing private and/or municipal and/or state and/or federal commercial enterprises or providers to deal in said investors and said duties;
recruiting clients-investors by said providers;
recruiting clients-duties by said providers;
establishing by said providers contracts with said client-investors comprising the obligation of said clients to make investments;
establishing by said providers contracts with said clients-duties comprising the obligation of said providers to satisfy said clients by said investments;
establishing by said providers a contract with authorities concerning mutual rights and obligations to be kept by said providers and said authorities comprising:
taking permission of free and/or licensed or any other kinds of marketing among providers and potential/actual clients-investors and clients-duties;
providing relevant information to be spread among participants of said marketing;
marketing among providers, investors and duties;
distributing possible income among clients;
executing said contracts.

19. A method of 18 wherein said barrier is changed purposely and occasionally.

20. A method of 18 wherein said barrier is changed alternatively.
